(19) United States
(12) Patent Application Publication
(10) Pub. No.: US 2012/0195200 A1
(43) Pub. Date: Aug. 2, 2012

(54) METHOD AND APPARATUS FOR HIERARCHICAL POLICING

(76) Inventor: Joe Regan, Auburn, CA (US)

(21) Appl. No.: 13/227,963

(22) Filed: Sep. 8, 2011

Related U.S. Application Data
(60) Provisional application No. 61/437,985, filed on Jan. 31, 2011.

(51) Int. Cl. H04L 12/26

(52) U.S. Cl. 370/235.1

(57) ABSTRACT

The invention includes a method and apparatus providing a hierarchical policer in which parent and child policers are atomically coupled with each other and responsively adapt policer operation.

### CROSS-REFERENCE TO RELATED APPLICATION

Applicant claims the benefit of prior provisional patent application Ser. No. 61/437,985, filed Jan. 31, 2011, which application is incorporated herein by reference.

### FIELD OF THE INVENTION

The invention relates to the field of communication networks and, more specifically, to packet policers.

### BACKGROUND OF THE INVENTION

Routers are typically architected with a hierarchical buffer or traffic queue structure in which traffic or data flows passing through the router are buffered by various buffers or queues depending upon the input port from which the data flow is received, the output port to which the data is transmitted, and the switching element or elements (switching fabric) used to route the data between the input and output ports.

Each buffer is typically managed using a policing function in which a counter or bucket associated with the buffer is incremented (i.e., “credits” are added to the bucket) in response to a timer function representing a corresponding buffer output packet flow rate. The counter or bucket associated with the buffer is decremented (i.e., “credits” are deducted from the bucket) in response to the number of packets stored in the buffer. In operation, the bucket count starts at zero, is incremented according to the timer function, and decremented according to the input packet flow to the buffer.

A decreasing count represents an increasing utilization level of the corresponding buffer. A count indicative of a utilization level below a threshold utilization level (e.g., 80%) indicates a nominal buffer utilization level (i.e., condition “green”). A count indicative of a utilization level above the threshold utilization level indicates an overutilization condition (i.e., condition “yellow”). In response to a condition yellow, the policing function typically issues a warning to a buffer control/management function to inform it that the utilization is trending toward an overflow condition. In response to a count of zero, indicative of a utilization level at or above 100% (i.e., condition “red”), the policing function issues an alarm to the buffer control/management function to inform it that the buffer is experiencing an overflow condition.

In response to either a warning or alarm, the buffer control and management function may operate to selectively drop some packets intended to be stored and/or already stored in the buffer such that the effective input packet rate and, therefore, utilization level of the buffer is reduced.

Policers may implement various functions either singly or in combination to mark packets for subsequent dropping. Traffic flows may be police based upon class, service level, priority and so on. No policing functions include Committed Information Rate (CIR), Peak Information Rate (PIR), Maximum Information Rate (MIR), buffer threshold levels and so on. Typically, CIR<=PIR<=MIR<=line rate.

Typical policing functions utilize PIR Buckets (having red or green state) and/or CIR Buckets (having green or yellow states). A PIR bucket is used for any type of buffer and indicates whether an overflow condition exists (red) or does not exist (non-red state). A CIR bucket is class oriented and used for buffers operating on particular classes of traffic (e.g., voice, streaming media, non-priority data and the like).

Unfortunately, within the context of a router in which packets pass through a hierarchy or sequence of input buffers, switch fabric buffers and/or output port buffers, dropped packets at one buffer reduce the utilization level of the one buffer as well as the utilization levels of the buffers sequentially following the one buffer. That is, dropped packets associated with a parent buffer (having a parent police function) impact the utilization level of the child buffer (having a child police function).

### SUMMARY OF THE INVENTION

Various deficiencies in the prior art are addressed through the invention of a method, apparatus and system for processing traffic flowing through elements controlled using hierarchically arranged policers wherein downstream policers are atomically coupled to respective upstream policers to propagate packet or flow discard information thereto, and upstream policers use the packet or flow discard information to adapt their own discard decision making process.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an apparatus benefiting from embodiments of the present invention;

FIG. 2 depicts a high-level block diagram of a network element portion according to one embodiment;

FIG. 3 depicts a high-level block diagram of a hierarchical policer suitable for use in the network element portion of FIG. 2;

FIG. 4 depicts a method according to one embodiment of the present invention; and

FIG. 5 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

Various embodiments provide hierarchically arranged policers operative to improve the efficiency of traffic flowing through policed network elements and/or sub-elements. Information pertaining to the discard of packets at downstream policers is coupled back to hierarchically corresponding upstream policers, which responsively adapt to their operation to avoid dropping packets if possible.

For example, each of a plurality of policers within a hierarchical arrangement of policers operates according to a CIR, PIR, FIR or other policing function. Each of the downstream policers is atomically coupled to at least one hierarchically corresponding upstream policer. Each upstream policer atomically coupled to a downstream pacer adapts its operation in response to an indication that a corresponding downstream pacer will allow more packets to pass.

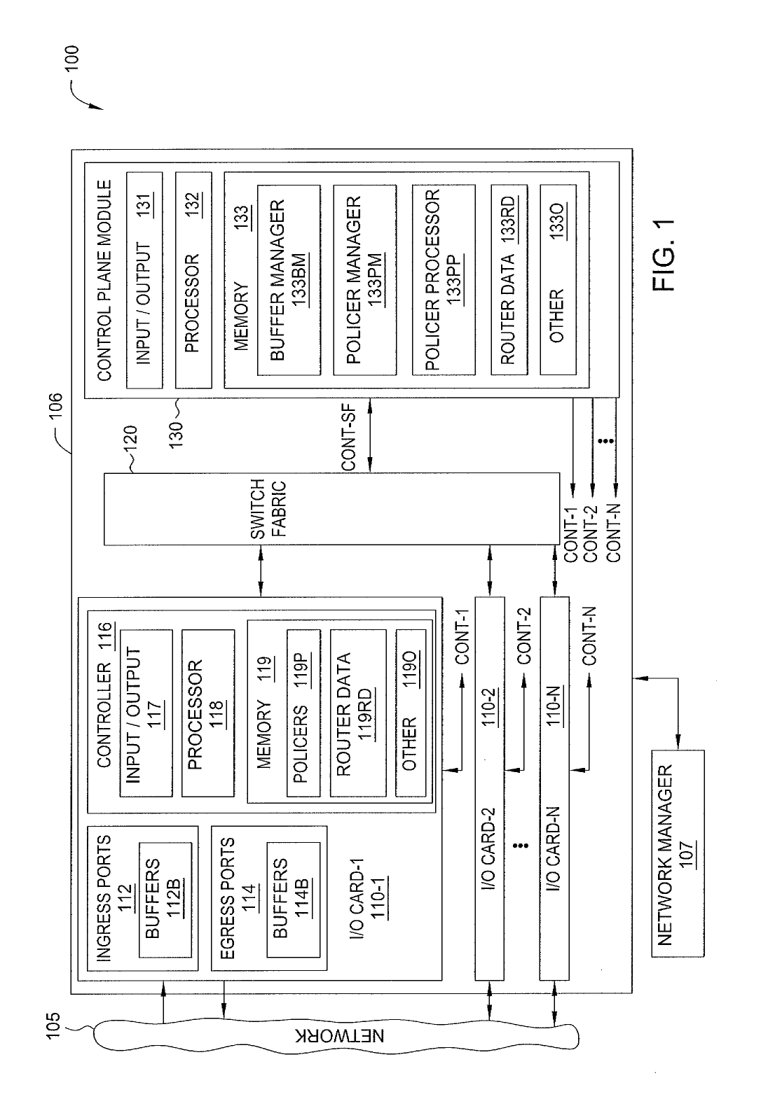

FIG. 1 depicts a high-level block diagram of an apparatus benefiting from embodiments of the present invention. Specifically, FIG. 1 depicts a router 106 in communication with a network 105 and a network manager 107.

The router 106 includes a plurality of input output (I/O) cards 110-1, 110-2 and so on up to 110-N (collectively I/O cards 110), a switch fabric 120 and a control plane module 130. The control plane module 130 controls the operation of the I/O cards 110 and switch fabric 120 by respective control signals CONT.

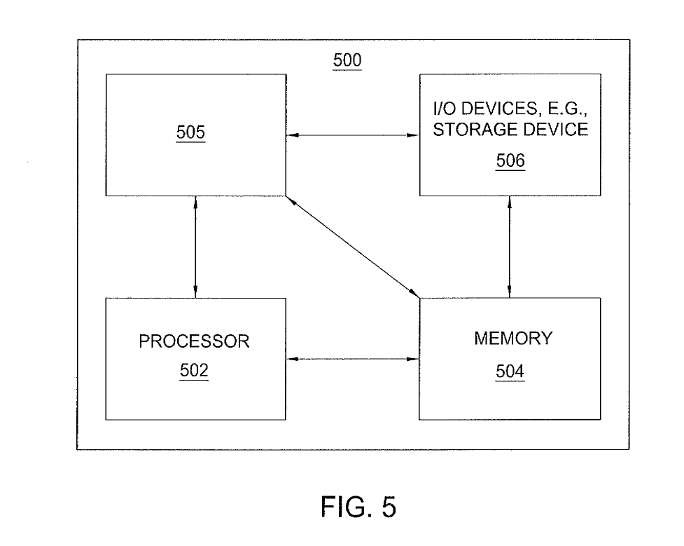

Each of the I/O cards 110 includes a plurality of ingress ports 112 including corresponding ingress ports buffers 112B, a plurality of egress ports 114 including corresponding egress port buffers 114B, and a controller 116 including an I/O module 117, a processor 118 and memory 119. The memory 119 is depicted as including software modules, instantiated objects and the like to provide policers 119P, routing data 119RD and other functions 119O. The controller 116 may be implemented as a general purpose computing device or specific purpose computing device, such as described below with respect to FIG. 5.

The I/O cards 110 operate to convey packets between the network 105 and the switch fabric 120. Packets received at a particular ingress port 112 of an I/O card 110 may be conveyed to the switch fabric 120 or back to the network 105 via a particular egress port 112 of the I/O cards 110. Routing of packets via the I/O cards 110 is accomplished in a standard manner according to routing data provided by the control plane module 130, which may be stored in the routing data portion of memory 119.

The switch fabric 120 may comprise any standard switch fabric such as electrical, optical, electro-optical, MEMS and the like.

The control plane module 130 receives from a network manager 107 configuration data, routing data, policy information, policer information and other information pertaining to various management functions. The control plane module 130 provides management and operations data to the network manager 107, including data such as configuration data, status data, alarm data, performance data and the like.

The control plane module 130 comprises an I/O module 131, a processor 132 and memory 133. The memory 133 is depicted as including software modules, instantiated objects and the like to provide a buffer manager 133BM, a policer manager 133PM, a policy processor 133PP, routing data 133RD and other functions 133O. The control plane module 130 may be implemented as a general purpose computing device or specific purpose computing device, such as described below with respect to FIG. 5.

The buffer manager 133BM operates to manage the configuration of the various policers such that they conform to the buffer structure provided by, illustratively, ingress ports, egress ports, switch fabric and so on. The buffer manager 133 BM also interacts with the various buffers to determine whether soft or hard limits have been reached, such as an overutilization warning limit (e.g., 80% of buffer utilization level), an overutilization alarm limit (e.g., 95% of buffer utilization level) and so on of the buffers operative within the context of the router 106

The policer manager 133PM operates to define and manage the various policers to be instantiated at, illustratively, the I/O cards 110. The policer manager 133PM communicates the number, type, operating parameters and/or other characteristics of policers to be instantiated within the context of the router 106.

The policy processor 133PP operates to process policy information such as service level agreement (SLA), traffic classification constraints, subscriber/user constraints, differentiated service levels, differentiated QoS levels/parameters and, generally, any other policy related parameter impacting the number, type, operating parameters and/or other characteristics of the policers to be instantiated within the context of the router 106.

The routing data 133RD operates to process routing information such that packets or traffic flows received at ingress ports are routed to appropriate egress ports within the context of the router 106. The routing data 133RD may include routing tables, protection or fault recovery information and so on.

Generally speaking, policers 119P instantiated at various I/O cards 110 or switch fabric 120 are defined in terms of parameters conveyed by the policer manager 133PM in accordance with the policing goals defined by the policy processor 133PP.

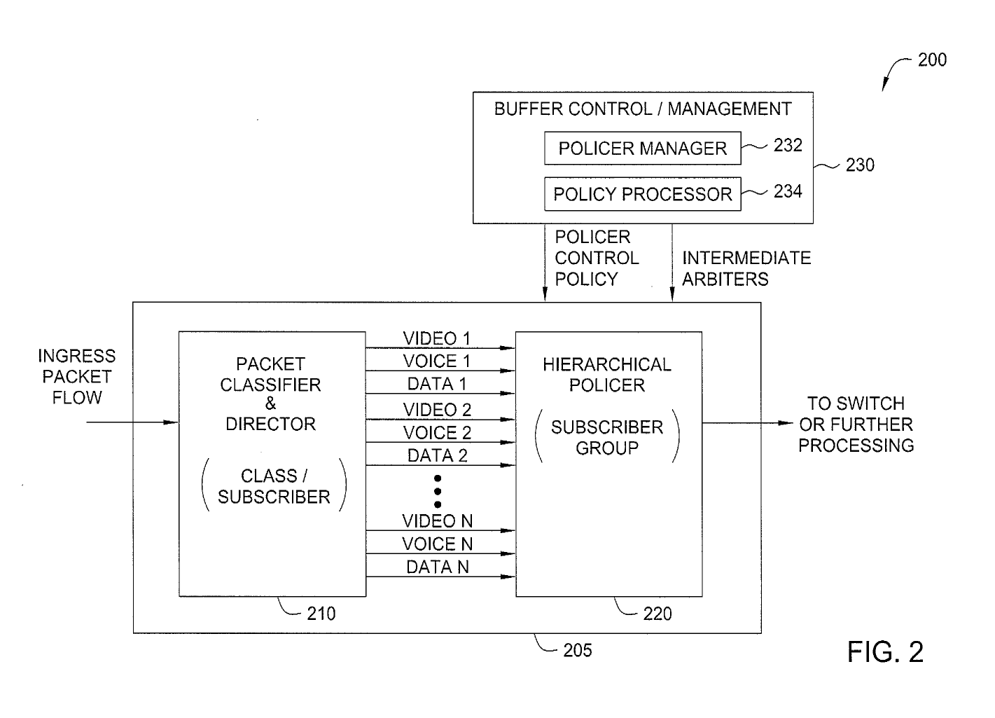

FIG. 2 depicts a high-level block diagram of a network element portion according to one embodiment. For example, FIG. 2 may be implemented within the context of an ingress card in a packet routing or switching system wherein only those packets corresponding to specific policed functions are coupled to a switching fabric for subsequent routing to a destination.

A packet classifier and director 210 receives an ingress packet flow and responsively classifies the packets according to, illustratively, video, voice, data or other classifications. Packet classifier and director 210 routes streams of classified packets to protocol based policers 220. The packet classifier and director 230 may be instantiated function within the memory 119 of the I/O card 110 discussed above with respect to FIG. 1.

Protocol based policers 220 implement a protocol based policing function according to embodiments of the invention. In one embodiment of the invention, a specific cost structure is derived from a service level agreement (SLA) and enforced using the hierarchical policer 220.

The packet classifier and director 230 and the hierarchical policer 220 may be implemented in an environment 205 comprising hardware, software or combination thereof.

In one embodiment, a buffer control/management function 230 includes a policer manager 232 and a policy processor 234. The policy processor 234 adapts policy information associated with service level agreements (SLAs) or other policy sources to define how various buffers within a hierarchical system should behave. The policer manager 232 is used to instantiate policers in a manner implementing the policy-based buffer behavior. The buffer control/management function 230 provides policer control policy information and intermediate arbiter information to the software environment 205 implementing the packet classifier and director 230 and the hierarchical policer 220.

Generally speaking, various embodiments provide apparatus, methods and/or systems configured to police packets associated with a plurality of service consuming entities within a group of service consuming entities. For each service consuming entity, a first-tier plurality of class policers is configured to provide respective class-based policing of packets associated with said service consuming entity. In addition, for each service consuming entity, a second-tier policer is configured to provide respective total bandwidth policing of packets associated with said service consuming entity. Finally, for the group of service consuming entities, a third-tier policer is configured to provide aggregate bandwidth policing of packets associated with said group of service consuming entities.

For each service consuming entity, one or more of the respective first-tier plurality of class policers is atomically coupled to the respective second-tier policer. A policing parameter of the one or more of the respective first-tier plurality of class policers is adapted in response to information received from the respective second-tier policer.

In various embodiments, one or more of said second-tier policers is atomically coupled to said third-tier policer. A policing parameter of the one or more second-tier policers is adapted in response to information received from the third-tier policer.

Policing parameters that may be adapted in response to information received from atomically coupled downstream policer include, illustratively, minimum/guaranteed bandwidth, maximum/allowed bandwidth, average bandwidth, priority or other quality of service (QoS) parameter.

In a class/subscriber embodiment, class-based packet flow (video, voice, data, specified application data and so on) is policed for each subscriber at a first-tier, individual subscriber total packet flow is policed at a second-tier, and aggregated or subscriber group packet flow is policed at a third-tier.

In a location/corporate embodiment, class-based packet flow (video, voice, data, specified application data and so on) is policed for each corporate location at a first-tier, individual corporate location total packet flow is policed at a second-tier, and aggregated corporate packet flow is policed for all corporate locations at a third-tier.

More or fewer tiers within the hierarchical policing function may be implemented. For example, the location/corporate embodiments may also include individual employee policing as one of more locations. Additionally, different individual employees may be associated with different levels of service. Moreover, the hierarchical policing function may be used to automatically implement changes in cost models or service models based upon changes in service level agreements.

It should be noted that while the packet classification function and packet routing/director function are depicted as being implemented by a single functional element, it will be appreciated that multiple functional elements may be used to implement these functions. In particular, in various embodiments, the packet classifier is used to classify all incoming traffic. Any specific processing functions such as per-subscriber, per-site or, more generally, per-entity processing functions are addressed by other functional elements.

In various embodiments, parent and child policers are atomically coupled and interact with each other according to various functions, including class policing, strict policing, fair policing and so on.

Various embodiments provide a logical topology in which parent and child policers are instantiated as a hierarchical policer of various policer types (CIR, PIR etc.) using various threshold levels. The hierarchically disposed policers are atomically coupled such that earlier policers receive information from later or subsequent policers, which information is used by the earlier policers to adapt their operation by modifying threshold levels and/or policer type.

In various embodiments, video class policers provide 0.5 Mbps of high priority bandwidth and 0.5 Mbps of low pretty bandwidth, voice class policers provide 160 Kbps of high priority bandwidth and so on. Other parameters may be used depending upon the architecture of the system, the services to be policed and so on, as known to those skilled in the art.

As an example, a voice traffic flow policer (e.g., 210₁₁) may be set to 160 kbps, since voice will typically not exceed 120 kbps. A policer for the voice class may have a timer function operating in accordance with the 160 kbps data rate. If there is a red discard based on queue discard, then the child counter is also adjusted to reflect the fact that additional bandwidth is made available.

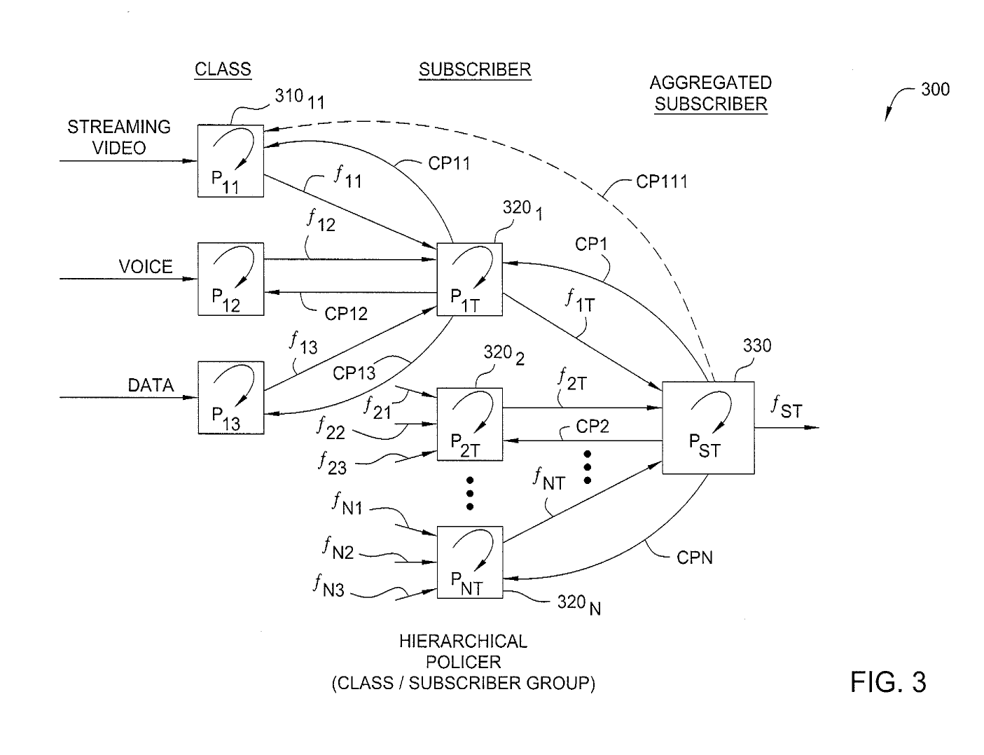

FIG. 3 depicts a high-level block diagram of a hierarchical policer suitable for use in the network element portion of FIG. 2. Specifically, the hierarchical policer 300 of FIG. 3 is suitable for implementing the hierarchical policer 220 discussed above with respect to FIG. 2. FIG. 3 depicts a hierarchical policer implementing first-tier class policing, followed by second-tier entity policing, followed by third-tier aggregated entity policing.

Each service consuming entity may comprise a subscriber within a group of subscribers of an access network provider, such as a 3G or 4G wireless provider. Each service consuming entity utilizes one or more classes of traffic. Each service consuming entity is entitled to a respective level of service, such as defined by a total bandwidth allocation. The entire group of consuming entities is constrained by a maximum aggregated level of service, such as a maximum aggregated bandwidth allocation.

Each of the various policers is instantiated according to policy requirements associated with service level agreements and the like. Each of the policers is adapted to process specific traffic or packet flows through various buffers. Referring to FIG. 3, the first-tier policers for only one service consuming entity or subscriber is shown. However, it will be appreciated that first-tier policers for each of the “N” service consuming entities or subscribers within a group of service consuming entities or subscribers operates in substantially the same manner.

Specifically, a video class policer 310₁₁ polices streaming video packets associated with a first subscriber to provide a policed traffic flow signal f₁₁; a voice class policer 310₁₂ polices voice packets associated with the first subscriber to provide a policed traffic flow signal f₁₂; and a data class policer 310₁₃ polices data (i.e., non-video/non-voice) packets associated with the first subscriber to provide a policed traffic flow signal f₁₃. Each of the first-tier policers causes packets to be dropped or marked for dropping from corresponding buffers according to specific criteria, the remaining packets being processed by a second-tier or subscriber-based policer 320₁.

Similarly, though not shown in FIG. 3, a video class policer 310₂₁ polices streaming video packets associated with a second subscriber, a voice class policer 310₂₂ polices voice packets associated with the second subscriber, and a data class policer 310₂₃ polices data packets associated with the second subscriber. The first-tier policers for the second subscriber provide respective traffic flow signals f₂₁, f₂₂, and f₂₃. Similarly, the first-tier policers for a third subscriber provide respective traffic flow signals f₃₁, f₃₂, and f₃₃.

In one embodiment of the invention, a hierarchical policing function is implemented wherein each of a plurality of subscribers receives up to three different classes of packets; namely, video, voice and/or data packets.

A first-tier policer (310) is instantiated to enforce bandwidth limits or other policies associated with each of the video, voice and/or data packet classes for each subscriber. A second-tier policer (320) is instantiated to enforce bandwidth limits or other policies associated with each subscriber. A third-tier policer (330) is instantiated to enforce bandwidth limits or other policies associated with a group of subscribers. The third-tier policer is atomically coupled to each of the second-tier policers.

Each of the second-tier policers may be atomically coupled to its respective first-tier policers. The third-tier policer may be atomically coupled to the second-tier policers and/or the first-tier policers. The hierarchical policing function so implemented operates to adapt the bandwidth limits or other policies associated with data packet classes in response to available individual subscriber bandwidth and/or available aggregate subscriber bandwidth. Generally speaking, some or all of the downstream policers are atomically coupled to some or all of the respective upstream policers to propagate packet or flow discard information thereto; upstream policers use the discard information to adapt their packet discard decision making process.

Generally speaking, embodiments of the invention may be used to address inefficiencies in policing traffic flows through hierarchical levels of any packet switching or routing device. The various embodiments described herein find particular utility within the context of a network switch or router in which ingress buffers, switch fabric buffers, egress buffers and the like are arranged in a hierarchical fashion and policed using a hierarchical policer instantiated in response to profile or service information, such as provided via a service level agreement (SLA) or via a network operator management or control function. Thus, the hierarchical arrangements of input buffers, switch fabric buffers and/or output port buffers are adapted by a control algorithm via the corresponding hierarchy of policers. Other embodiments and applications are contemplated by the inventor.

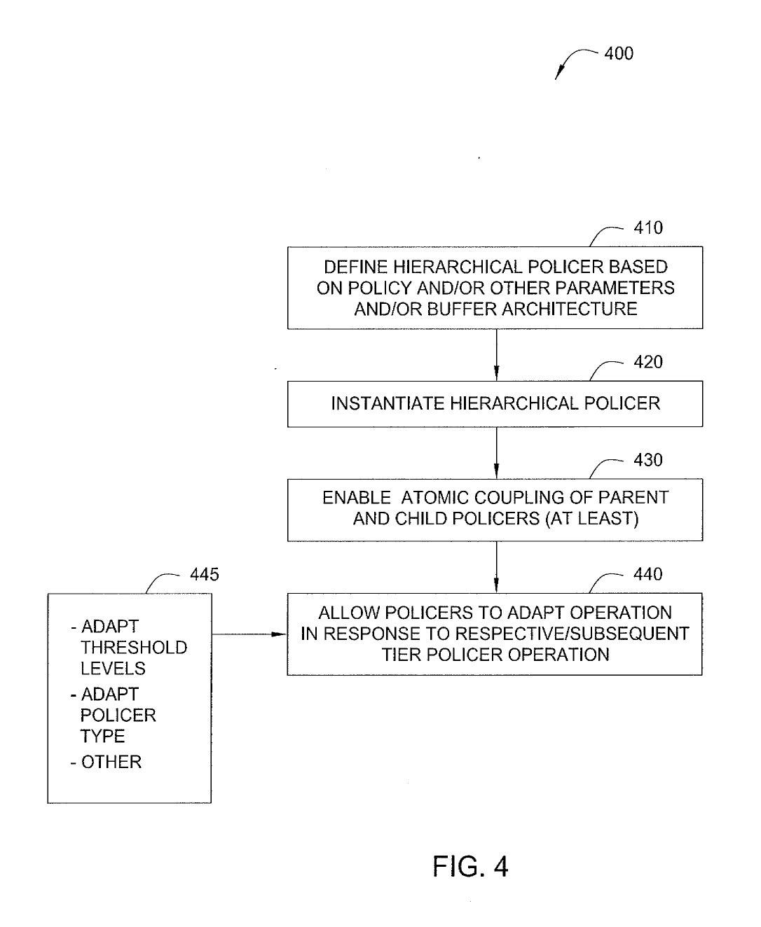

FIG. 4 depicts a flow diagram of a method according to one embodiment. Specifically, FIG. 4 depicts a method suitable for implementing and adapting the operation of a hierarchical policer.

At step 410, a hierarchical policer is defined based upon policy and/or other parameters, as well as the buffer architecture to be policed.

At step 420, the defined hierarchical policer is instantiated in memory to begin processing buffer-related packets according to various policing functions.

At step 430, atomic coupling of the parent and child policers within the hierarchical policer is enabled. As previously noted, atomic coupling between hierarchical policers may involve some or all of the policers, some or all of the hierarchies and so on.

At step 440, the operation of the various instantiated policers is allowed to adapt in response to information provided by respective subsequent tier policer operations. Referring to box 445, such adaptation may comprise adapting threshold levels used by CIR, PIR or other policer types, adapting policer type used for a particular policer, or other adaptations including instantiating new policers within the hierarchy and the like.

In one embodiment, a counter or bucket associated with each respective buffer in a hierarchical arrangement of buffers starts at zero, is incremented according to an input packet flow to the buffer and decremented according to a timer function representing an output packet flow rate. In this manner, burst tolerance for higher priority flows may be provided and/or fairness among various flows may be monitored and enforced.

In one embodiment, a Policer Control Policy instantiates a parent policer when the policy is implemented. The policy defines the decrement rate of the policer, which defines the traffic flow associated with the parent policer. Priority MBS thresholds are used to build priority based burst thresholds. Multiple policers are combined or arranged to provide a hierarchical function that is flexible and efficient.

One or more intermediate arbiters may be used to bundle child policers into groups or subgroups where each of the groups or subgroups represents virtual or logical representation of their respective traffic flows. In this manner, customer specific, subscriber specific, client specific, service specific, class specific and so on cost models may be rapidly implemented and enforced. The arbiters arbitrate the amount of bandwidth to be handed off at each tier to the policers. The adaptive distribution of bandwidth is useful since there is often little knowledge about how a customer ultimately wants their bandwidth distributed.

For example, a root arbiter may define a maximum rate (e.g., 20 Mbps) associated with the total traffic buffered for a particular port or other entity. A first-tier arbiter may be used to assign various weights to specific policer functions, traffic classes (priority levels) and the like. It is contemplated that about any number of priority levels may be used in various embodiments.

The intermediate arbiters communicate with scheduling loops to ensure that each group or subgroup, however defined, receives an appropriate amount of bandwidth or other defined service level. In this manner, a sophisticated policer function is implemented wherein manipulation of threshold levels of parent policers is provided to avoid bandwidth starving at the parent policers while providing fairness of the bandwidth distribution. In various embodiments, the scheduler operates at the ingress/egress nodes trying to offer packets to a switch fabric or line port and in accordance with the policy parameters.

In various embodiments, the policer is implemented as a leaky bucket or a state machine. In hierarchical implementations, a mapping or atomic coupling exists between child and parent policers.

Various embodiments provide hardware policing; others use hardware and software to make the policing adaptive with regards to various policies, priorities and so on. Decisions to discard or not discard a packet are made based on color (priority) and the like. The output of policers is per-packet accurate.

Multiple child policers are used to provide output traffic flows from a parent policer where the flows are aggregated together. In this manner, hierarchical policers instantiated in accordance with an SLA operate to enforce SLA QoS data requirements. This enforcement may also include user sanctions such as bit rate throttling and other punitive measures, which measures may be implemented using the policers.

Dropped packets may be those associated with specific criteria, such as customer service level (e.g., gold, silver or bronze QoS service levels), traffic flow error correction ability (e.g., traffic flows with very robust FEC or other schemes), traffic flow type (e.g., voice, streaming video, streaming audio, bulk file or data transfers and the like), input port, output port and so on. Essentially, packets are dropped according to a hierarchical order based on one or more of the criteria.

In one embodiment, a hierarchical sequence of buffers is associated with a corresponding hierarchical arrangement of policers in which parent buffer police functions are implemented using CIR buckets having green/yellow states and child buffer police functions are implemented using FIR buckets having blue/orange states. Moreover, the blue/orange states of the child police functions are used to adapt the threshold levels associated with the yellow/green states of the parent police functions.

An FIR bucket (blue/orange state) is optionally used to select a threshold value within its parent policer. That is, in response to a change in state associated with an FIR child buffer policer, the threshold level associated with a CIR or PIR policed buffer is adapted such that bandwidth is not wasted by constraining specific traffic flows that do not need to be constrained. The parent policer threshold is differential with respect to the child state.

In one embodiment, a hierarchical policer provides a mechanism supporting arbitrary bandwidth management. Specifically, component policers within the hierarchical policer do not adapt to instantaneous modifications of PIR policed buffers.

FIG. 5 depicts a high-level block diagram of a general purpose computer suitable for use in performing the functions described herein. As depicted in FIG. 5, system 500 comprises a processor element 502 (e.g., a CPU), a memory 504, e.g., random access memory (RAM) and/or read only memory (ROM), a packet processing module 505, and various input/output devices 506 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It will be appreciated that computer 500 depicted in FIG. 5 provides a general architecture and functionality suitable for implementing functional elements described herein and/or portions of functional elements described herein. Functions depicted and described herein may be implemented in software and/or hardware, e.g., using a general purpose computer, one or more application specific integrated circuits (ASIC), and/or any other hardware equivalents.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, transmitted via tangible media and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus configured to police packets associated with a plurality of service consuming entities within a group of service consuming entities, the apparatus comprising:
for each service consuming entity, a first-tier plurality of class policers configured to provide respective class-based policing of packets associated with said service consuming entity;
for each service consuming entity, a second-tier policer configured to provide respective total bandwidth policing of packets associated with said service consuming entity; and
for said group of service consuming entities, a third-tier policer configured to provide aggregate bandwidth policing of packets associated with said group of service consuming entities;
wherein, for each service consuming entity, one or more of the respective first-tier plurality of class policers is atomically coupled to the respective second-tier policer;
wherein a policing parameter of the one or more of the respective first-tier plurality of class policers is adapted in response to information received from the respective second-tier policer.

2. The apparatus of claim 1, wherein one or more of said second-tier policers is atomically coupled to said third-tier policer, wherein a policing parameter of the one or more second-tier policers is adapted in response to information received from the third-tier policer.

3. The apparatus of claim 1, wherein said class policers operate to police at least video class packets and voice class packets.

4. The apparatus of claim 1, wherein each service consuming entity comprises a subscriber to a service provider, and the group of service consuming entities comprises a plurality of subscribers to said service provider.

5. The apparatus of claim 4, wherein policing parameters associated with the first, second and third-tier policers are defined by a service level agreement (SLA).

6. The apparatus of claim 1, wherein each service consuming entity comprises an individual customer location, and the group of service consuming entities comprises a plurality of customer locations.

7. The apparatus of claim 6, wherein policing parameters associated with the first, second and third-tier policers are defined by a service level agreement (SLA).

8. A method for policing packets associated with a plurality of service consuming entities within a group of service consuming entities, the method comprising:
for each service consuming entity, policing respective packets according to respective class policers;
for each service consuming entity, policing respective packets according to a respective total bandwidth policer; and
for said group of service consuming entities, policing packets according to an aggregate bandwidth policer; wherein
for each service consuming entity, one or more of the respective class policers is atomically coupled to the respective total bandwidth policer; and
a policing parameter of the one or more of the respective class policers is adapted in response to information received from the respective total bandwidth policer.

9. The method of claim 8, wherein one or more of said second-tier policers is atomically coupled to said third-tier policer, wherein a policing parameter of the one or more second-tier policers is adapted in response to information received from the third-tier policer.

10. The method of claim 8, wherein said class policers operate to police at least video class packets and voice class packets.

11. The method of claim 8, wherein each service consuming entity comprises a subscriber to a service provider, and the group of service consuming entities comprises a plurality of subscribers to said service provider.

12. The method of claim 11, wherein policing parameters associated with the first, second and third-tier policers are defined by a service level agreement (SLA).

13. The method of claim 1, wherein each service consuming entity comprises an individual customer location, and the group of service consuming entities comprises a plurality of customer locations.

14. The method of claim 13, wherein policing parameters associated with the first, second and third-tier policers are defined by a service level agreement (SLA).

15. A computer readable medium including software instructions which, when executed by a processer, perform a method for policing packets associated with a plurality of service consuming entities within a group of service consuming entities, the method comprising:
for each service consuming entity, policing respective packets according to respective class policers;
for each service consuming entity, policing respective packets according to a respective total bandwidth policer; and
for said group of service consuming entities, policing packets according to an aggregate bandwidth policer; wherein
for each service consuming entity, one or more of the respective class policers is atomically coupled to the respective total bandwidth policer; and
a policing parameter of the one or more of the respective class policers is adapted in response to information received from the respective total bandwidth policer.

16. A computer program product, wherein a computer is operative to process software instructions which adapt the operation of the computer such that computer performs a method for policing packets associated with a plurality of service consuming entities within a group of service consuming entities, the method comprising:
for each service consuming entity, policing respective packets according to respective class policers;
for each service consuming entity, policing respective packets according to a respective total bandwidth policer; and
for said group of service consuming entities, policing packets according to an aggregate bandwidth policer; wherein
for each service consuming entity, one or more of the respective class policers is atomically coupled to the respective total bandwidth policer; and
a policing parameter of the one or more of the respective class policers is adapted in response to information received from the respective total bandwidth policer.
